(19) United States
(12) Patent Application Publication
(10) Pub. No.: US 2007/0296301 A1
(43) Pub. Date: Dec. 27, 2007

(54) STATOR CORE

(76) Inventor: Min Kyu Lim, Jinhac-si (KR)

Correspondence Address: KED & ASSOCIATES, LLP, P.O. Box 221200, Chantilly, VA, 20153-1200, US

(21) Appl. No.: 11/767,551

(22) Filed: Jun. 25, 2007

(30) Foreign Application Priority Data
Jun. 26, 2006 (KR) 10-2006-0057555

(51) Int. Cl. H02K 7/00; H02K 1/00; H02K 1/06

(52) U.S. Cl. 310/216; 310/217; 310/67 R; 29/596

(57) ABSTRACT

A stator core is disclosed. The stator core is constructed in a structure in which stress of the stator core is minimized when a stator is manufactured in a spiral fashion, whereby workability is improved. The stator core includes a yoke formed in the shape of a band, a plurality of teeth protruding outward from one side of the yoke, the teeth being arranged at predetermined intervals in the longitudinal direction of the yoke, and a plurality of notches formed at the yoke in the shape of a cutout such that the notches are arranged at predetermined equal intervals, the notches being disposed between the respective neighboring teeth.

### CROSS-REFERENCE TO RELATED APPLICATION

This application claims the benefit of Korean Patent Application No. 10-2006-0057555, filed on Jun. 26, 2006, which is hereby incorporated by reference in its entirety as if fully set forth herein.

### BACKGROUND OF THE INVENTION

1. Field of the Invention

The present invention relates to a stator, and more particularly, to a stator core constructed in a structure in which stress and spring back of the stator core are minimized when a stator is manufactured in a spiral fashion, whereby workability is improved.

2. Discussion of the Related Art

Based on the drive mode thereof, a motor may be classified as an indirect connection type motor which indirectly transmits a drive force to an object to be rotated using a pulley and belt or a direct connection type motor, such as a brushless direct current (BLDC) motor, in which a rotor of the motor is directly connected to an object to be rotated such that a drive force from the motor is directly transmitted to the object.

In the indirect connection type motor, the drive force of which is not directly transmitted to the object but indirectly transmitted to the object via a belt wound on a pulley of the motor or the object, however, energy loss occurs, and a large noise is generated, during the transmission of the drive force.

For this reason, there has been increasingly used the direct connection type motor, i.e., the BLDC motor, which solves the problems caused from the indirect connection type motor.

The BLDC motor includes a rotor directly connected to an object to be rotated for transmitting a drive force to the object and a stator for generating a magnetic force, when electric current is supplied to the stator, to rotate the rotor using an attractive force and a repulsive force between the stator and the rotor.

The stator may be manufactured by stacking a plurality of blanked cores or by stacking a core in a spiral fashion.

For the stator manufactured by stacking the blanked cores, a large amount of core scrap is generated during blanking the cores, whereby material costs are increased. For the stator manufactured by stacking the core in the spiral fashion, on the other hand, a base material is stacked in the spiral fashion, whereby the generation of core scrap is minimized, and therefore, the increase of material costs is minimized.

A conventional stator manufactured by stacking a core in a spiral fashion will be described with reference to FIGS. 1 and 2.

FIG. 1 is a perspective view illustrating a conventional stator core stacked in a spiral fashion, and FIG. 2 is a plan view of the conventional stator core after the stacking of the stator core is completed.

As shown in FIGS. 1 and 2, the stator core includes a yoke 1 formed in the shape of a ring and a plurality of teeth 3 protruding from the outside of the yoke 1 such that a coil is wound on the teeth 3.

When manufacturing the stator, it is required to bend the stator core, which is a sheet iron blanked in the shape of a band, in a spiral fashion. As a result, large stress is generated at the inside of the yoke 1.

In order to minimize the stress, as shown in FIGS. 1 and 2, notches 5 are formed at the inside of the yoke 1. Specifically, the notches 5 are formed by partially cutting the yoke between the teeth 3.

However, the stator core with the above-stated construction has the following problem.

The number of the notches 5 formed between the respective neighboring teeth 3 is one, and therefore, it is not possible to minimize stress generated at the inside of the yoke 1 when winding the stator core.

### SUMMARY OF THE INVENTION

Accordingly, the present invention is directed to a stator core that substantially obviates one or more problems due to limitations and disadvantages of the related art.

An object of the present invention is to provide a stator core constructed in a structure in which stress of the stator core, generated when winding the stator core to manufacture a stator in a spiral fashion, is minimized.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a stator core includes a yoke formed in the shape of a band, a plurality of teeth protruding outward from one side of the yoke, the teeth being arranged at predetermined intervals in the longitudinal direction of the yoke, and a plurality of notches formed at the yoke in the shape of a cutout such that the notches are arranged at predetermined equal intervals, the notches being disposed between the respective neighboring teeth.

Preferably, the notches are formed at the other side of the yoke.

Preferably, the notches are formed in the shape of a polygonal cutout. More preferably, the notches are formed in the shape of a triangular cutout.

Alternatively, the notches may be formed in the shape of a semicircular cutout.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a conventional stator core stacked in a spiral fashion;

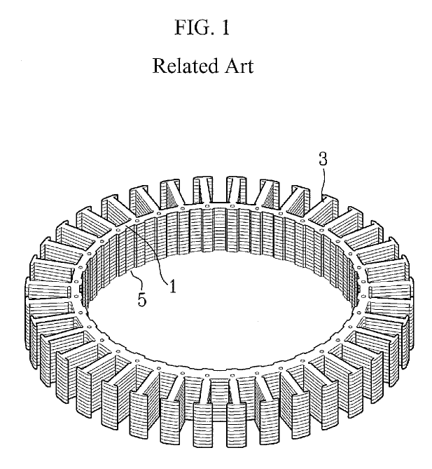

FIG. 2 is a plan view of the conventional stator core after the stacking of the stator core is completed;

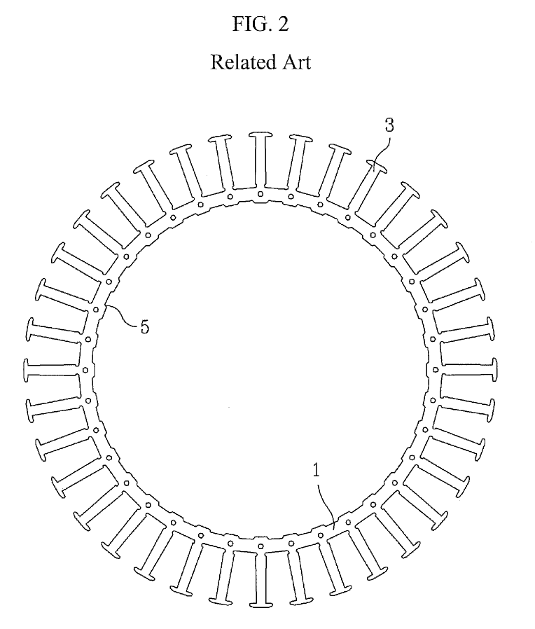

FIG. 3 is a perspective view illustrating a stator core according to a first embodiment of the present invention wound in a spiral fashion;

FIG. 4 is a plan view of FIG. 3;

FIG. 5 is an enlarged view illustrating “A” part of FIG. 4; and

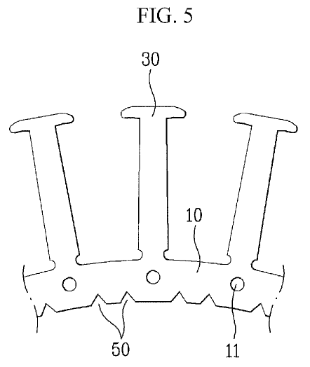

FIG. 6 is a plan view, in part, illustrating principal components of a stator core according to a second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

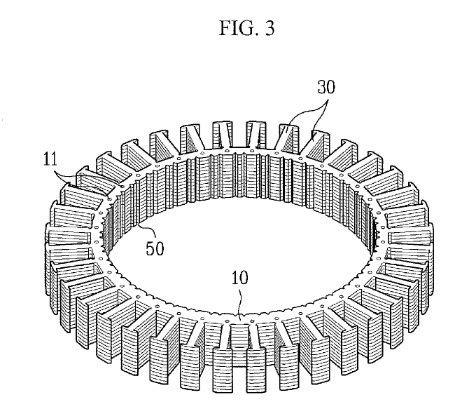

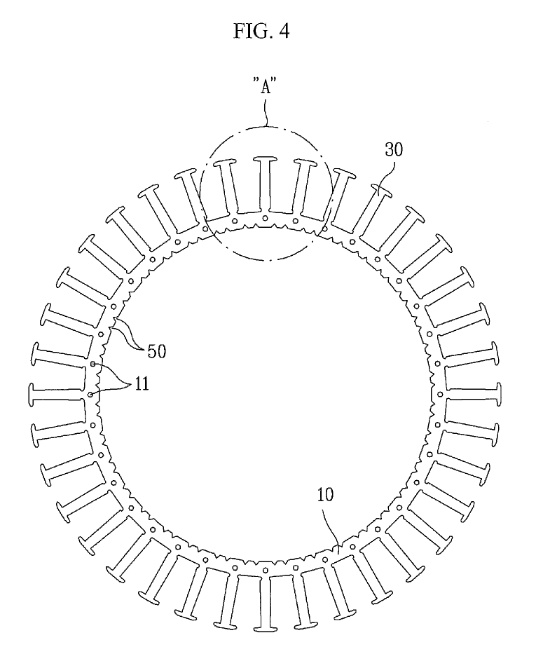

First, a stator core according to a first embodiment of the present invention will be described in detail with reference to FIGS. 3 and 4.

The stator core includes a yoke 10, teeth 30, and notches 50.

The yoke 10 is formed in the shape of a band having a large length to width ratio.

Also, the yoke 10 is provided with a plurality of guide holes 11, into which guide pins of a winding apparatus (not shown), which winds the stator core in a spiral fashion to stack the stator core, will be inserted.

The teeth 30 protrude outward from one side of the yoke 10 such that a coil for generating electric current in the stator is wound on the teeth 30. The teeth 30 are arranged at equal intervals in the circumferential direction of the yoke 10.

The notches 50 serve to minimize stress generated at the yoke 10 when the stator core is plastically deformed. Specifically, the notches 50 are formed at the inside of the yoke 10, i.e., the side of the yoke 10 opposite to the teeth 30, in the shape of a cutout.

At this time, the notches 50 are arranged at predetermined equal intervals along the inside edge of the yoke 10. Preferably, at least two notches 50 are formed at the yoke 10 between the respective neighboring teeth 30.

This is because greater stress is generated at the yoke 10 between the respective teeth 30 when bending the stator core in a spiral fashion.

Consequently, a plurality of notches 50 are formed at the inside of the yoke 10 where large stress is generated to minimize stress generated at the inside of the yoke 10, whereby the stator core is smoothly stacked.

At this time, it is preferable for a plurality of notches 50 to be formed between the respective neighboring teeth 30. More preferably, the number of the notches 50 between the respective neighboring teeth 30 is two.

If the number of the notches 50 between the respective neighboring teeth 30 is three or more, stress generated at the yoke 10 is reduced, and therefore, it is possible to easily bend the stator core. In this case, however, the strength of the yoke 10 may be reduced, and therefore, the stator core may be broken when bending the stator core.

Preferably, the notches 50 are formed in the shape of a polygonal cutout to maximize the dispersion of the stress generated at the yoke 10. More preferably, the notches 50 are formed in the shape of a triangular cutout as shown in FIG. 4.

Hereinafter, a process for stacking the stator core with the above-stated construction to manufacture a stator will be described.

The stator core, manufactured, for example, by press, has a predetermined size. The stator core is supplied to a winding apparatus (not shown), having a plurality of guide pins arranged on the circumference thereof, while the teeth 30 of the stator core face outward.

The guide pins of the winding apparatus are sequentially inserted into the guide holes 11 formed in the yoke 10 in the direction in which the stator core is supplied. As a result, the linear yoke 10 is bent in the shape of an arc about the notches 50, by the action of the guide pins of the winding apparatus, and therefore, the yoke 10 is plastically deformed.

As the winding apparatus is rotated once, the stator core is changed into the shape of a circle.

As the winding apparatus is continuously rotated, the stator core is sequentially stacked upward from the lowermost layer. After the process for stacking the stator core is completed, the stacked stator core is pressurized in the thickness of the stator core such that the layers of the stator core are brought into tight contact with each other.

As described above, the stator according to the first embodiment of the present invention is manufactured by stacking the stator core in a spiral fashion.

The stator core according to the first embodiment of the present invention is characterized in that the notches are formed at the yoke in the shape of a triangular cutout, as can be clearly understood from the above description.

On the other hand, a stator core according to a second embodiment of the present invention is characterized in that the notches are formed at the yoke in the shape of a semicircular cutout.

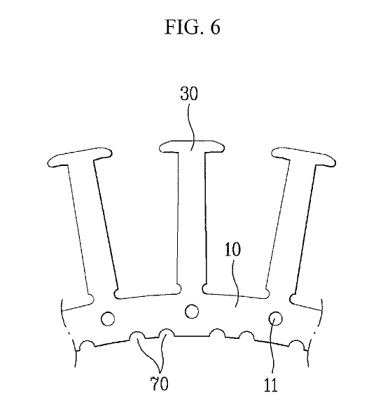

The stator core according to the second embodiment of the present invention will be described hereinafter in detail with reference to FIG. 6.

FIG. 6 is a plan view, in part, illustrating principal components of a stator core according to a second embodiment of the present invention. Components of the stator core according to the second embodiment, which are identical to those of the stator core according to the first embodiment, are denoted by the same reference numerals.

Referring to FIG. 6, the stator core includes a yoke 10, teeth 30, and notches 70.

The yoke 10 is formed in the shape of a band having a large length to width ratio.

Also, the yoke 10 is provided with a plurality of guide holes 11, into which guide pins of a winding apparatus (not shown), which winds the stator core in a spiral fashion to stack the stator core, will be inserted.

The teeth 30 protrude outward from one side of the yoke 10 such that a coil for generating electric current in the stator is wound on the teeth 30. The teeth 30 are arranged at equal intervals in the longitudinal direction of the yoke 10.

The notches 70 serve to minimize stress generated at the yoke 10 when the stator core is plastically deformed. Specifically, the notches 70 are formed along the inside of the yoke 10, i.e., the side of the yoke 10 opposite to the teeth 30, in the shape of a cutout.

At this time, the notches 70 are arranged at predetermined equal intervals along the inside edge of the yoke 10. Preferably, a plurality of notches 70, specifically at least two notches 70, are formed at the yoke 10 between the respective neighboring teeth 30.

According to the second embodiment of the present invention, however, the notches are formed at the yoke in the shape of a semicircular cutout, unlike the first embodiment of the present invention.

Consequently, stress generated at the stator core is minimized, when bending the stator core in a spiral fashion to stack the stator core, whereby the stator core is smoothly stacked.

A process for stacking the stator core according to the second embodiment is identical to that of the previous first embodiment, and therefore, a description thereof will not be given in order to avoid the repetition of the description.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As apparent from the above description, the stator core of the present invention with the above-stated construction according to the present invention has an effect in that a plurality of notches are formed at the yoke between the respective neighboring teeth, and therefore, it is possible to minimize stress generated at the yoke when the yoke is wound.

Consequently, the yoke is smoothly wound, and therefore, workability of the stator is improved.

What is claimed is:

1. A stator core comprising:
a yoke formed in the shape of a band;
a plurality of teeth protruding outward from one side of the yoke, the teeth being arranged at predetermined intervals in the longitudinal direction of the yoke; and
a plurality of notches formed at the yoke in the shape of a cutout such that the notches are arranged at predetermined equal intervals, the notches being disposed between the respective neighboring teeth.

2. The stator core according to claim 1, wherein the notches are formed at the other side of the yoke.

3. The stator core according to claim 1, wherein the notches are formed in the shape of a polygonal cutout.

4. The stator core according to claim 3, wherein the notches are formed in the shape of a triangular cutout.

5. The stator core according to claim 1, wherein the notches are formed in the shape of a semicircular cutout.

6. The stator core according to claim 1, wherein the number of the notches formed at the yoke between the respective neighboring teeth is two.
